(19) United States
(12) Patent Application Publication
(10) Pub. No.: US 2023/0329268 A1
(43) Pub. Date: Oct. 19, 2023

(54) Honey Tea

(71) Applicant: Eun Kyung LEE, Wando-gun Jeollanam-do (KR)

(72) Inventor: Eun Kyung LEE, Wando-gun Jeollanam-do (KR)

(21) Appl. No.: 18/001,479

(22) PCT Filed: Jun. 11, 2021
(86) PCT No.: PCT/KR2021/007313

§ 371 Date: Jun. 22, 2023

(30) Foreign Application Priority Data
Jun. 11, 2020 (KR) 10-2020-0071086
Feb. 25, 2021 (KR) 10-2021-0025682
Mar. 2, 2021 (KR) 10-2021-0027522
Jun. 2, 2021 (KR) 10-2021-0071836

(51) Int. Cl. A23F 3/14; A23F 3/40

(52) U.S. Cl. CPC A23F 3/14; A23F 3/405

(57) ABSTRACT

The present disclosure relates to making a new kind of honey by adding well-dried acacia flowers to acacia honey and packaging the obtained product in single-serving stick-type individual packs to allow acacia honey flower tea to be consumed. Also, the present disclosure relates to mixing fine powder obtained by crushing well-dried flowers well with honey in an appropriate combination and packaging the obtained product in single-serving individual packs or containers. Also, the present disclosure relates to mixing honey and well-dried fruit powder well in an appropriate ratio and additionally adding dried fruit slices or whole small dried fruit. In addition, the present disclosure relates to pickling fresh flowers in honey so that, due to physical and chemical changes to the honey, more beneficial ingredients can be consumed as compared to when the honey is consumed alone.

### TECHNICAL FIELD

Food manufacturing

### BACKGROUND ART

Existing natural honey and dried acacia flowers (including a variety of flowers) are used.
Freeze-drying or various other methods of flower drying are used.
Flower drying technology, beekeeping, and proper mixing technology
Fruit drying technology, crushing technology, beekeeping
Honey does not rot easily due to its high sugar content and various other ingredients. Applying this point, flowers with relatively low water content are added to and pickled in honey to allow components of the flowers to naturally dissolve in the honey while spoilage is prevented.

### DISCLOSURE

### Technical Problem

The present disclosure relates to development of a product in which honey is mixed with acacia flower tea that allows a user to immediately enjoy sweet honey-flavored acacia flower tea without separately adding honey.

Also, the present disclosure is directed to providing a method in which moisture-removed, dried flowers are used to allow honey and the dried flowers to be well-preserved after being mixed.

Also, the present disclosure allows a user to enjoy sweet acacia flower+honey tea anytime, anywhere.

Also, the present disclosure meets demand for both honey water and flower tea at the same time, thus providing a better product.

Also, the present disclosure allows dried flowers for flower tea to be made into powder and mixed with honey to be enjoyed as honey flower tea.

Also, the product is developed into convenient stick-type or single-serving individual packs to increase portability.

Also, flower powder is mixed with honey in an appropriate combination for the most suitable scent and taste.

Also, the present disclosure addresses the inconvenience of having to brew flower tea to properly taste the flavor.

Also, the present disclosure addresses the blandness of taste due to the absence of other flavors when only honey is consumed.

Also, the present disclosure addresses the inconvenience of having to separately enjoy honey and flower tea.

In addition, the present disclosure addresses the blandness of taste of flower tea.

### Technical Solution

A product of the present disclosure is provided as single-serving packs like honey sticks and is squeezed into a container and mixed with water to obtain flower honey tea (or honey flower tea). The product is provided as stick-type individual packs. The product may also be bottled and scooped to be consumed but is mostly provided as individual packs in various single-serving containers to improve convenience and portability.

The product may also be provided as single-serving individual packs in a disposable cup.

The product may be directly developed as a beverage.

The blandness of taste of flower tea may be addressed to be sweeter using honey, and the blandness of flavor when only honey water is consumed may be addressed by mixing honey water with powder obtained by crushing flowers.

In addition, honey and powder obtained by crushing flowers may be mixed in an appropriate combination and enjoyed.

### Advantageous Effects

Accordingly, by combining the beekeeping industry and the flower tea industry, synergy can be created between the two industries, and by allowing a user to enjoy the two beneficial ingredients for the body at the same time, it is possible to contribute to national health and beauty enhancement and contribute to farm profits.

Also, since a product released according to the present disclosure is the first of its kind around the world, the product has great potential for domestic and international sales. (Although stick-type honey mixed with flower components is available in foreign countries, the product according to the present disclosure is different therefrom in that flower extracts or flower components from which the shape of flowers has been removed are added.)

Also, the present disclosure opens up a new market with sweet honey-water flower tea.

Also, since flowers can be consumed as powder along with honey without a need to separately brew flower tea, the product according to the present disclosure dissolves well in cold and hot water.

Also, by making flowers into powder, active ingredients of the flowers can be directly consumed.

Also, by releasing a product which allows honey and flower powder to be consumed at the same time, food that is beneficial to health while having enhanced taste and flavor is introduced, which helps improve national health and promote a pleasant tea culture or a culture of consuming honey.

In addition, since the product according to the present disclosure can be consumed without being mixed with water, the present disclosure allows the two ingredients, honey and flower powder, to be consumed anytime, anywhere.

### DESCRIPTION OF DRAWINGS

FIG. 1 briefly shows an idea of how to mix acacia honey and dried flowers for acacia tea and how to commercialize the obtained product according to a first embodiment.

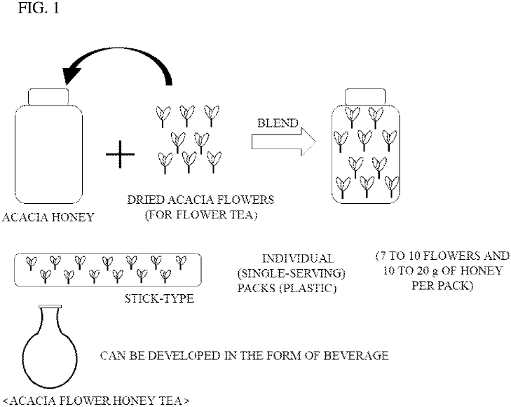

FIG. 2 shows that honey and powder obtained by crushing dried flowers are well-mixed in an appropriate combination according to a second embodiment.

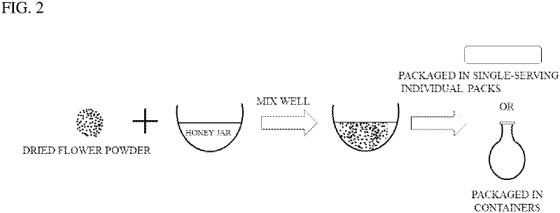

FIG. 3 shows making well-dried fruit into powder and mixing the powder with honey in an appropriate ratio that improves taste, and, according to the type of fruit, additionally adding dried fruit slices or whole small fruit, and then packaging the obtained product in stick-type single-serving individual packs or containers according to a third embodiment.

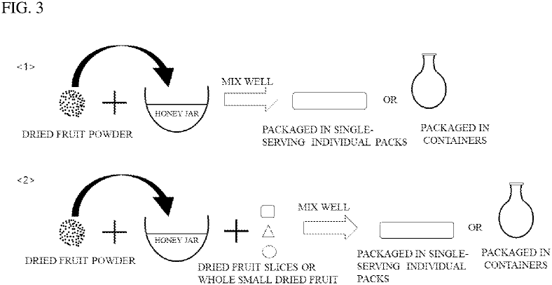

FIG. 4 shows that honey and fresh flowers are well-mixed, the obtained product is well-stored, and the product is packaged in various ways for commercialization according to a fourth embodiment.

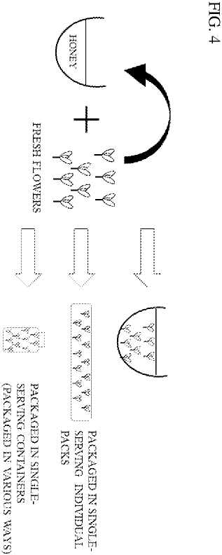

### MODES OF THE INVENTION

### First Embodiment: Acacia Honey Flower Tea or Acacia Flower Honey Tea

The core of the present disclosure is to make a new kind of honey by adding acacia honey and well-dried (moisture-removed) acacia flowers. The core of the present disclosure goes beyond just making honey by adding flowers but is to allow the honey to be enjoyed as tea by adding hot water.

Also, a machine for producing already-available stick-type honey is utilized to package the new kind of honey in stick-type packs. In this way, acacia honey flower tea or acacia flower honey tea may be consumed anywhere.

Of course, the new kind of honey may be consumed alone or utilized elsewhere according to a user’s intention.

The new kind of honey may be put in various types of individual packaging containers, in addition to being packaged in stick-type packs, for commercialization.

### Second Embodiment: Honey Flower Tea Containing Dried Flower Powder

Flowers are dried well using freeze-drying or various other flower drying methods and then made into fine powder and mixed with honey in an appropriate combination.

The obtained product is packaged in single-serving individual packs or put in appropriate containers to be enjoyed anytime, anywhere.

Fine powder obtained by crushing well-dried flowers is mixed well with honey in an appropriate combination, and the obtained product is packaged in single-serving individual packs or put in containers. The product developed according to the second embodiment has enhanced taste and flavor and allows honey and powder obtained by crushing flowers to be consumed at the same time. In this way, active ingredients of the flowers can be easily and conveniently enjoyed with honey, and it is good for health. Also, the inconvenience of having to separately brew flower tea to enjoy can be addressed.

### Third Embodiment: Fruit Powder Honey Tea

Well-dried fruit is made into powder and mixed well with honey. Also, additionally, dried fruit may simply be cut and added, or uncut whole small fruit may be added to allow a user to enjoy a chewy texture. The obtained product may be packaged in individual packs to be consumed in place of fruit juice or fruit tea just by adding water anytime, anywhere. The obtained product allows only ingredients beneficial to the body to be consumed and may also be consumed alone without water as when consuming stick-type honey.

When only honey is consumed, it is not possible to experience various flavors other than a sweet flavor. The obtained product addresses such a disadvantage and is packaged in individual packs to increase portability and allow a user to conveniently consume fruit and honey ingredients. The obtained product improves the taste of honey sticks made with only honey, improves well-being, and allows a user to experience various flavors. The obtained product allows honey to be conveniently enjoyed in various ways. Additionally, dried fruit slices or whole small fruit may be added to make the obtained product chewier, and the obtained product may be mixed with carbonated water or water to allow a user to experience the true flavor of fruit along with fruit powder while chewing fruit.

As an example, in a case in which lemon powder and lemon slices are mixed with honey, when the obtained product packaged in individual packs is mixed with water or carbonated water, lemonade can be enjoyed right away without any other complicated process.

Since the obtained product uses only two ingredients that are good for the body and is packaged in individual packs, the obtained product allows the two beneficial ingredients to be conveniently enjoyed in various ways anytime, anywhere.

Fruit dried well using freeze-drying or various other fruit drying methods is crushed well into fine particles to be made into powder and is mixed well with honey.

Here, according to the type of fruit, dried fruit slices or whole dried fruit, when the fruit is small, may be additionally added or not added depending on the fruit.

Fruit may be additionally added if the fruit tastes good when chewed and may not be additionally added if not.

### Fourth Embodiment: Fresh Flower Honey Tea

From research, it was found that, when freshly-picked flowers are put in honey and pickled, the scent of the flowers and various components of the flowers are dissolved in honey and can be preserved for a long time without being spoiled in the honey.

Using the above research result, fresh flowers and honey were packaged together in single-serving packs or containers to develop fresh flower honey tea.

The flowers cause an osmotic pressure in the honey, causing the honey to become thinner unlike the original honey. It was found that the texture of the honey also changes as moisture is released from the flowers and various components come out of the flowers. Active ingredients of the fresh flowers cause slight chemical and physical changes in the honey, and when the honey is consumed, the active ingredients of the flowers can be consumed at the same time.

The honey containing the fresh flowers is put in containers to be developed as a product that allows active ingredients of the flowers and the honey to be consumed at the same time.

Also, the product may be packaged in single-serving packs to be consumed as fresh flower honey tea and may be consumed in various ways due to components of the flowers being dissolved therein.

Flowers grown organically or without pesticides in pristine nature or collected from uncontaminated nature are mixed with honey. Fresh flowers pickled in honey are naturally obtained. The obtained product may be stored well in containers and may be commercialized with a shelf life for a certain period of time.

The obtained product may be packed in tubular containers, general containers, or various single-serving packs such as single-serving sticks and may be conveniently consumed as fresh flower honey tea.

1. A honey tea, which is a new kind of tea, obtained by adding well-dried, moisture-removed acacia flowers to acacia honey and commercializing the acacia flowers and honey.

2. The honey tea of claim 1 in which developed to be packaged into stick-type individual packs or various other single-serving individual packs to form a new category referred to as real honey flower tea which is able to be consumed as tea just by adding (hot) water, the honey tea being able to be commercialized in stick-type packs and various other individual packs and being able to be commercialized in cups for convenience stores.

3. The honey tea of claim 1 in which obtained by adding various dried flowers, other than acacia flowers, to various kinds of honey in the same way as in claim 1.

4. The honey tea of claim 1 in which acacia flowers and honey are mixed to be developed as a beverage contained in a packaging container that is able to be consumed immediately.

5. A honey tea in which honey and powder obtained by crushing well-dried flowers for flower tea are mixed in an appropriate combination, and the obtained product is packaged in single-serving individual packs or containers.

6. The honey tea of claim 5 in which well-dried fruit made into powder is mixed well with honey, and the obtained product is packaged in single-serving individual packs or containers.

7. The honey tea of claim 5 in which well-dried fruit made into powder is mixed well with honey, and according to characteristics of different types of fruit, well-dried fruit slices or, in the case of small fruit, whole dried fruit is additionally added to allow a user to enjoy a chewy texture and further enhance taste, and the obtained product is packaged in single-serving individual packs or containers, each individual pack containing an appropriate small number of pieces of dried fruit.

8. A honey tea in which edible fresh flowers pickled in honey that are able to be preserved for a certain period of time are put in containers for commercialization or put in various single-serving containers such as single-serving stick packs for commercialization.

9. The honey tea of claim 8 in which fresh flowers pickled in honey that are obtained using chemical and physical changes that occur when fresh flowers are pickled in honey are utilized in developing various derivatives.

10. The honey tea of claim 8 in which components obtained by pickling fresh flowers in honey are extracted and utilized in developing other products such as cosmetic products, health food, and other types of food.
